(19) United States
(12) Patent Application Publication
(10) Pub. No.: US 2007/0080175 A1
(43) Pub. Date: Apr. 12, 2007

(54) Candy pick & mix merchandiser system

(76) Inventor: Klaus P. Petersen, Basking Ridge, NJ (US)

Correspondence Address: ERNEST D. BUFF;ERNEST D. BUFF AND ASSOCIATES, LLC., 231 SOMERVILLE ROAD, BEDMINSTER, NJ, 07921, US

(21) Appl. No.: 11/247,870

(22) Filed: Oct. 11, 2005

(51) Int. Cl. B67D 5/56; B67D 5/06; G01F 11/10

(52) U.S. Cl. 222/185.1; 222/129; 222/357

(57) ABSTRACT

A candy pick and mix merchandiser system has a small foot print. Depth adjustable merchandiser vessels have an array of vertically stackable candy delivery bins of varying sizes and configurations. A tongue and groove attachment means attaches and interlocks the vertically stackable candy delivery bins to form a stacked configuration wherein the bins are stacked one over another in an interlocked array. Vertical stability strengthener means strengthen the interlocked array of vertically stacked candy bins. The vertical stability strengthener means comprise a plurality of male and female plugs adapted for insertion into a plurality of vertically and horizontally parallel and side-by-side flush perforations in frontal lower corners of vertically disposed left and right acrylic panels of said bins. The candy delivery bins are front or rear loading. Funnel and rake bins in which a rake passes through a narrow aperture in the funnel minimize entry of contaminants into the bin. Other candy delivery configurations include stackable scoop bin, stackable tongue bin, and stackable open bin.

### BACKGROUND OF THE INVENTION

1. Field of the Invention

The present invention relates to merchandising systems for the storage, display and self-service dispensing of bulk and packaged candy, confectionery and health food and other food products; and more particularly to compact candy confectionary health food and other food dispensers that occupy minimal floor space, provide a plurality of dispensing options, and enable the pick and mix, self-service selection and delivery of a wide variety of candies, confectionery, health and other foods, whether unwrapped, wrapped or otherwise packaged, hard or soft, dry or moist, to proceed efficiently, hygienically and in a consumer-friendly and convenient, self-service environment.

2. Description of the Prior Art

Many patents address issues related to dispensing of tickets and other objects including candy.

U.S. Pat. No. 86,277 to Brewster discloses a card rack. This card rack is designed for dispensing tickets in a railroad station. Tickets are packed in movable drawers. Each of the drawers may be pulled forward but is automatically retracted by the action of an elastic cord or spring J. The '277 patent discloses a card rack adapted to dispense railroad tickets, which are essentially “two-dimensionally” shaped. It does not suggest delivering three-dimensionally shaped objects, such as candy. Movable drawers C and elastic cord or spring J exhibit a structure that is unsuited for candy delivery. U.S. Pat. No. 272,708 to Kirk discloses a ticket case. The ticket case has many ticket boxes that are hung from hooks. The weight of the tickets forces the tickets forward for easy retrieval. When a ticket box is empty, it is removed from the hook and refilled without disturbing other ticket boxes. The ticket case disclosed by the '708 patent does not suggest a candy dispenser. The hooks of the ticket box, and the movement of the boxes (which are forced forward by the weight of the tickets) exhibit a structure and function that is unsuited for delivering candy.

U.S. Pat. No. 529,528 to Goff discloses a grocer's cabinet. The cabinet has a store counter A with weighing scale track D carrying wheeled scales E, which may be moved from one compartment G to another so that spices, pepper, rice, sugar, flour and the like may be weighed and sold. These bins G deliver sugar and the like through discharge chute M, which is covered or uncovered by operating gate N provided with handle n. The grocer's cabinet counter A has several drawer openings B′ with drawers C having pull knobs c. The cabinet has drawers for storage of articles away from air while a limited number of compartment boxes contain sugar, spice, rice flower and the like, which need to be weighed and delivered to a scale through a chute with a closure gate. This grocer's cabinet does not deliver candy, has only few loosely packed compartment boxes, and provides no means to rake candy to a chute, depending entirely on free flow of substances within the boxes.

U.S. Pat. No. 673,976 to Clampitt discloses a case or cabinet. The case is designed for containing tickets in separate receptacles, which are individually detachable from the cabinet. In the figures shown below, A is the wall of the case or cabinet and A1 separates the receptacle for tickets. A hook A3 secures the receptacles through a hole in the case or cabinet. This case includes locations for receiving detachable receptacles, which carry tickets. The receptacles are secured in the case by hooks through holes in the case. Tickets carried by the case are essentially two-dimensional objects. Consequently, the '976 patent does not suggest a system for delivering three-dimensional objects, such as candy.

U.S. Pat. No. 3,172,713 to Rupert discloses a vending machine apparatus. The vending machine is on the backside of the front seat of a taxicab and contains a number of vending machine capsules. Each vending machine capsule contains one product and delivers it to the customer through an opening in the bottom of the capsule when coins are inserted. The number of products available is strictly limited. No provision is provided for mixing candy.

U.S. Pat. No. 4,211,343 to Hughes et al. discloses a bulk dry food product storage, display and dispensing apparatus. This apparatus comprises nearly identical horizontal modules with a series of hoppers. The interior of each hopper is provided with a bottom, the curvature of which is varied for easy dispensing of dry food products including rice, beans, seeds corn and the like. A rake passes through an aperture near a spout. Candy is pushed through the spout using the rake and delivered to a plastic bag. This bulk dry food product storage, display and dispensing apparatus is designed for dispensing candy. Since the angle of inclination of the hopper is fixed and its bottom is curved, candy will not freely flow towards the spout. No closure is provided for the spout. The apparatus has limited number of bins, which are nearly identical, and cannot readily accommodate differently sized bins. The size of the dispensing apparatus cannot be changed.

U.S. Pat. No. 4,311,257 to Greico et al. discloses an apparatus for dispensing foodstuffs from a sanitized container. This apparatus dispenses dry, typically unwrapped, foodstuffs such as nuts, candies, and other food products from a container while maintaining their sanitary integrity. A raking device permits the user to urge foodstuffs within a sanitary container through a flexible seal where they are dispensed through a snout. A nonaligned aperture of the snout prevents inadvertent entry of foreign matter into the sanitized container. An enclosing lid of the container is provided with a central aperture for receiving a rake. Foodstuff is displaced by the rake towards a second aperture in the lid directly below the central aperture, thereby delivering the foodstuff through a spout in the lid. A flexible seal closes and seals the second aperture. The apparatus disclosed by the '257 patent does not afford multiple selection of candy; but rather can only deliver one candy at a time. The lid and the rake mechanism must be removed in order to fill the container with foodstuff. Since the lid is not transparent, the user has no knowledge of the candy that is being raked.

U.S. Pat. No. 4,331,335 to Starkweather discloses a hardware elements storage dispenser and game device. The device is basically a multi-compartment cubicle having a box array or construction. Each cubicle of this device is for storing and dispensing objects with magnetic properties including paper clips and the like. The cubicle of the device has two sidewalls, a back wall and a bottom which is inclined towards the open face of the device. The elevated rear portion of the bottom is not magnetized while the front portion facing the open face of the device is magnetized and therefore retains and presents to the user the magnetizable articles stored in the device. Optionally a portion of the front open face above the magnetized end may be covered. The device of the hardware elements storage dispenser and game device is not appointed for dispensing candy. Non-metallic objects, such as candy, are not magnetizable, and would not be suitable for use with the device. Clear functional and structural differences militate against use of the hardware elements storage dispenser and game device of the '335 patent for housing and dispensing candy.

U.S. Pat. No. 4,349,128 to Sanfilippo discloses a movably mounted dispenser for bulk material. Several bulk materials are mounted on a frame and the mount is slidable due to carriage links so that the containers may be moved forward and backward. When a horizontal force is applied in the rearward direction, the bottom of the container is inclined more towards the outlet, driving the bulk goods towards the outlet. The outlet is provided with a handle, which adjusts a gate. The containers in the movably mounted dispenser for bulk material are of the same size and inclined in the same manner, being mounted in a movable mechanism. No rake is provided to direct the bulk material towards the outlet. The inclination of the bottom of the container by movement is relied on to bring the bulk material towards the outlet. Such a delivery method is unsuited for candy, which is oftentimes sticky.

U.S. Pat. Nos. 4,592,494, 4,650,098 and 4,889,263 to Ellis et al. disclose a sealed barrier container. This sealed barrier container provides limited access of the user to the products in the container and dispenses metered quantities of the product from a hopper to an exit chute. A reciprocating scoop is controlled by external means to dispense a metered quantity of the product from the hopper through the exit chute. The U.S. Pat. No. 4,889,263 patent uses a boot to provide reciprocating and orbital movement of the scoop. This is a single barrier containing a single product. The customer sets the amount of product desired by rotating a control knob that turns a star shaft delivering a selected quantity of the product into an inclined ramp. The product delivered to the ramp is moved downwards towards the exit chute using a scoop claw operated by a reciprocating movement of a control handle without manually touching the product. This sealed barrier container is a single unit and does not deliver a selection of or mix containing many candies. The star shaft is incapable of handling unwrapped sticky candy or soft candy, which may be readily cut. Moreover, the star shaft will become stuck in a fixed position by the wedging action of the candy.

U.S. Pat. No. 4,718,578 to Radek et al. discloses a bulk goods dispenser. The bulk goods dispenser has a bin for holding the bulk goods, which can be removed by a manipulator mounted in a dispensing unit communicating with the interior of the bin. The removed bulk goods are temporarily collected in a chute prior to being dispensed by a trap door into a bag or a container for weighing, which is attachable to walls of the chute. The trap door is held in a closed position by a spring member until released by a handle. The manipulator has a scoop for moving the bulk goods over a slanting wall in the bin. The bin has a slidable cover, which can be locked. The dispenser unit can also be locked to the bin. A false bottom can vary the holding capacity of the bin. The bulk goods dispenser can be easily taken apart for cleaning and can be locked so that access into the interior of the dispenser cannot be obtained by the general public. Multiple identical bulk good dispensers are mounted on a rack together with a weighing scale, trash bin, and a plastic bag dispenser. The bag is positioned on the exit chute and held in place by horns. The bulk goods are collected in a chute temporarily by a manipulator and released to the collection bag by operating a spring loaded trap door, activated by a handle. The trap door may be locked in place to prevent bulk goods theft. These bulk goods dispensers are identical and cannot therefore handle a variety of candies having different levels of softness and stickiness. The candy is brought to the chute by the operation of the manipulator, which action could be rough on soft candies, and cause candies to be crushed or broken.

U.S. Pat. No. 5,105,991 to Johnson discloses a bulk goods dispenser. This dispensing apparatus comprises a product bin for storing the food product, and a regulator for controlling the flow of the food product. Extending through an aperture in the front of the apparatus is a raking member, by which the product may be manipulated along an inclined front panel into a dispensing unit. The product may then be dispensed by operation of a hinged and weighted front door, which forms a dispensing spout when opened. The dispensing apparatus may further comprise a funnel assembly, which acts in concert with the regulator panel to control the speed of the food product entering into the product bin. In this device a single unit is utilized to dispense bulk goods. The bulk goods in the bin are raked into a dispensing spout, which is opened to deliver the product. Even though the bottom of the goods dispenser is inclined, the goods have to be raked to the level of the spout; and this operation will crush soft candy. There is no free flow of the bulk goods into the delivery chute.

U.S. Pat. No. 5,560,519 to Moore et al. discloses a dispensers and dispenser arrays for displaying and dispensing bulk goods. Each dispenser has identical rear, bottom and front walls, and a baffle depending from the rear of the front wall. All of these are formed from an integral piece of transparent thermoplastic polymer. The front and bottom walls are angled down and up, respectively meeting at an acute angle. Identical side panels are adhered to the integral piece and have corner notches at the bottom so that the dispenser may be mounted on a pair of parallel rails. All of the tops are formed of rectangular pieces having identical dimensions. Usually, in use at least two rows of dispensers are mounted on two pairs of rails, one above the other. The tops of the top bins are permanently adhered to the integral piece and have a hole in them. All of the tops of the bottom row of dispensers are hinged to their respective back wall. Identical chutes are provided depending from the upwardly angled bottom wall portions. The chutes are rectangular and have a slot in their top wall and slots inside their side walls to receive and guide a sliding door. A hole in the extreme front of each dispenser allows a rake to be manipulated to pull candy into its chute. In order to lock the chutes, aligned holes are provided in the side walls, and a cylinder of the same inner dimension is affixed to the outside of each of the sliding doors. A locking cable, chain, or rod may be placed through the holes in all of the chutes and the cylinder affixed to the sliding doors to lock them. In order to lock the hinged tops, a right angle bent is adhered to the baffle at the top thereof. A cylinder identical to the cylinders adhered to the sliding doors is adhered to the top of the bent and fits through a hole in the hinged top. Another locking cable, chain or rod may be fitted through these cylinders to lock the hinged tops. In this bulk goods dispenser a series of bins is arranged in parallel. Each of the bins has a rake in the bottom to direct bulk goods such as candy into a dispensing chute. A variety of candies cannot be dispensed using this dispenser due to the large space required. The free flow of candy cannot occur through the convoluted passage provided. The rake will be ineffective to move soft sticky candy.

U.S. Pat. No. 6,705,687 to McGraw discloses a storage and display unit for cards and the like and a method for making the unit. This storage and display unit houses prepaid telephone calling cards, collectible cards, and the like. The storage and display unit provides card bins for visible storage of cards, which are readily accessible for removal as cards are sold. It provides space for a card of a specified type. The display is composed of transparent plastic. The unit is combinable with other units to assemble larger units. It comprises one or more bins holding cards that are for sale. The unit has a key-lockable cover to deter unauthorized removal of cards. This storage and display units for cards and the like and method for its use exhibit markedly different structure and function then the candy dispenser, since the cards are two dimensional sheets unlike candies. The card display unit would be inoperable if used to dispense candy.

U.S. Patent Application No. 2004/0211736 to Mason discloses a shelf and display device This display device has at least one shelf for modular merchandise units having a substantially flat base. The shelf has at least two spaced walls defining a channel between the walls. At least one support is disposed in the channel and receives the base of the merchandise unit or units. Each support has a rearward portion elevated at a first angle, a substantially horizontal forward portion, and an intermediate portion elevated at a second angle greater than the first angle and connecting the rearward and forward portions. When placed on the rearward portion of the support, the merchandise unit will descend by gravity to the forward portion for access to the unit in a selected presentation position. This shelf and display device is purely a support device, which may be inclined. The components comprising the support structure disclosed by the '736 patent application publication have different function and operation than a device used for dispensing various candies.

There remains a need in the art for a compact foot print candy pick and merchandiser system that delivers an assortment of candy having different characteristics. The system must successfully deliver the candy without cracking or fracturing candies of varied hardness and stickiness in a hygienic manner. The candy pick and mix merchandiser system arrangement must be changeable at the will of the merchant to display and deliver a variety of candy to the customer thereby changing the range of candy made available.

### SUMMARY OF THE INVENTION

The present invention provides a candy, confectionery, health and other foods pick and mix merchandiser system that has a compact footprint, and is especially suited for delivery of a wide variety of candies, confectionery, health and other foods, whether unwrapped, wrapped or otherwise packaged, hard or soft, dry or moist. Candy is reliably delivered by the system without being cracked or fractured, even when the candy has varied characteristics, such as hardness. Delivery is accomplished in a hygienic, efficient manner. The candy pick and mix merchandiser system arrangement is readily varied by the merchant to display and deliver a variety of candy shapes, sizes, textures, and packages to the customer, thereby increasing significantly the range of candy types and packages made available.

More specifically, there is provided a candy, confectionery, health and other foods pick and mix merchandiser system which incorporates a merchandiser main frame vessel in variable and adjustable widths, heights and depths within which a plurality of differently sized and differently configured dispensing bins for bulk and packaged candy, confectionery, health and other foods are placed. A plurality of merchandiser frame vessels are joined to each other using attachment means, thereby forming an array of candy dispensing units especially suited to deliver a large selection of candy having widely varying sizes and shapes for picking and mixing. The configuration of the bins is adapted to effectively deliver a specific candy with hardness, softness, dryness, moistness, wrapped and unwrapped properties that may differ significantly from other associated candies, which are disposed in close proximity within the bins. The adjustable merchandiser frame is provided with means for attaching shelves using support brackets. Each of the shelves may inclined at a selected angle with respect to the horizontal plane by adjusting a set of risers that support the shelf. Pluralities of candy dispensing bins are vertically stacked and are interlocked with each other using tongue and groove attachment of a pair of stacking tracks provided on the top and bottom of each bin. The stack of bins may be placed on the bottom floor of the merchandiser vessel as a stand alone vertically stacked candy dispensing bin array. Alternatively, the vertically stacked array of candy dispensing bins may be placed on a shelf, the angle of which may be inclined using the risers according to the preference of the merchant, based on candy type and stickiness for superior candy delivery. The vertically stacked array of candy dispensing bins can employ bins of different sizes and bin configurations. The candy delivery bins can also be stacked and arranged in a configuration chosen by the candy merchandiser for display appeal and customer convenience. In a preferred embodiment, the vertically stacked bins are prevented from tipping over by insertion of a pair of metallic support rods, which pass through two apertures in each candy delivery bin and through two apertures, one of which is located on the top of the merchandiser vessel and the second of which is located on the bottom thereof.

The tongue and groove interlocking of stackable candy delivery bins is accomplished by a pair of slidable tracks provided on top and a pair of slidable tracks provided on the bottom of each candy delivery bin. When one candy delivery bin is stacked above another candy delivery bin the slidable tracks engage to provide a tongue and groove locking arrangement. Any individual candy delivery bin may be easily slid out from a vertical stack providing the ability to remove an empty bin or change the candy delivery bin type.

The candy delivery bins are provided in a variety of configuration and sizes. Due to the flexibility provided by the design of the merchandiser vessel and the use of shelves, any size and type of candy delivery bin may be inserted into the vessel. The candy delivery bins are interlocked to each other by tongue and groove arrangement by a pair of slidable tracks provided both on top and bottom surfaces of each candy delivery bin. A stack of candy delivery bins may be placed on the bottom flat surface of the vessel or placed on a shelf which may be inclined at an angle to the horizontal plane. This angularity forces the candies in the candy dispensing bin towards the front of the bin and provides for easy flow of candy by gravity towards a chute that may be present in the front of the candy delivery bin. In one embodiment, the stacked bins are provided with vertical stability strengthener means comprising plastic, acrylic or metal male and female plugs, which are inserted in vertically and horizontally parallel and side-by-side flush perforations in the frontal lower corners of the vertical left and right acrylic panels of the bins. In another embodiment, such vertical stability is strengthened by a pair of supporting acrylic or metallic rods, which are inserted in vertically and horizontally parallel and side-by-side flush perforations in the frontal lower corners of the vertical left and right acrylic panels of the bins.

The candy delivery bins are provided in several configurations each designed for delivery of candy. The candy delivery bin types include a) Front-Loading and Stacking Funnel and Rake Bins, b) Rear-Loading and Stacking Funnel and Rake Bin, c) Stackable Scoop Bin, d) Stackable Tongue Bin, and e) Stackable Open Bin. The front loading and stackable funnel and rake bin is provided with a slotted opening for easy up and down movement of the rake, and a funnel opening through which the raked candy is dispensed. This arrangement limits entry of undue amounts of air and other contaminants into the candy dispensing bin, and facilitates hygienic candy delivery. The rear-loading feature has a similar functionality. Stackable scoop bins, stackable open bins and stackable tongue bins may be effectively used for unwrapped candy or wrapped and protected candy delivery.

More specifically, the front-loading and stacking funnel and rake bins and rear-loading and stacking funnel and rake bins are provided with a candy delivery funnel and a rake, which pulls the candy towards a front candy delivery chute. The rake handle passes through a narrow aperture, generally having the form of a slotted opening, above the funnel to limit the entry of air and other contaminants into the front-loading and stacking funnel and rake bins and rear-loading and stacking funnel, thereby preserving the quality of unwrapped candy.

Typically, the inclination of the shelves is adjustable, and the height of each shelve can also be changed in the merchandiser. The shelves are adjusted by metal pins that sit in pin holes. The riser is a 3-step millwork structure that sits on the interior base of the main frame and holds 3 acrylic boxes for the storage, display and dispensing of wrapped and packaged count and novelty goods.

In an alternative embodiment of the invention, the inclination of the shelves attached to the vessel frame may be adjusted by means of metal pins and pin holes, the height of which may be changed by the merchandiser. Since the shelves are used to position candy delivery stackable bins, the flow of the candy towards the front of the bin is accurately controlled. When pre-packaged packets of candy are placed on a shelf, the display characteristics of the packaged candy is improved by inclining the shelf to the horizontal plane. This provides improved visibility of candy packages by customers. The candy mix and pick merchandiser system has optional locking features to prevent theft of candy when the merchandiser system is placed in a public open access area.

Key features associated with the use of the candy pick and mix merchandiser system include, in combination, the means set forth below:
1. An adjustable main frame which functions as a vessel to attach adjustable merchandiser shelves, place on the bottom platform a 3-stepped slanted riser component, to attach adjustable merchandiser slat-wall components, to attach adjustable merchandiser pegboard components, to insert Point of Sale [POS] systems, and to carry and support stackable and interlocking acrylic candy delivery bins of different sizes and configurations for the storage, display and self-service dispensing of candy, confectionery, health and other foods;
2. Candy, confectionery, health and other foods delivery bins interlock using tongue-and-groove stacking arrangement;
3. Numerous combinations of storage, display, merchandising and dispensing fixtures, such as “funnel & rake” bins, “scoop” bins, “tongue” bins, “open” bins, adjustable shelves, adjustable risers, slat-wall components, pegboard components, spillage troths and other optional components;
4. Numerous options for assortments and varieties of combinations of unwrapped, wrapped, bagged or otherwise packaged candy, confectionery health food and other food products;
5. Integrated mobility capability of the System;
6. Approximately up to 12 times greater SKU count capacity, merchandising capability and space efficiency as compared to extant systems;
7. Almost unlimited options and combinations of aggregate and daisy-strung configurations of main frame vessels and internal modular components;
8. Optional portability of mini-systems, which can be removed and placed on cash desks or any other convenient self-service location;
9. Optional integrated or free-standing cup and/or bag holders for self-service portioning and purchase by the customer;
10. Optional integrated or free-standing signage with specific “How-to-Use” instructions, pricing information and generic or proprietary graphics;
11. Optional integrated and satellite Point-Of-Sale (“POS”) stations, including optional cash registers, electronic scales and supplies;
12. Integrated security of the system;
13. Hygienic “funnel & rake” bins;
14. Hygienic and clean spillage troths; and
15. Deterrence of vandalism of the candy pick and mix merchandiser system.

These features make the candy, confectionery, health and other foods pick and mix merchandiser especially well suited for self-service dispensing of candy, confectionery, health and other foods in an efficient, hygienic, convenient, safe and cost effective manner.

### BRIEF DESCRIPTION OF THE DRAWING

The invention will be more fully understood and further advantages will become apparent when reference is had to the following detailed description of the preferred embodiments of the invention and the accompanying drawing, in which:

FIG. 1a depicts the schematic view of the candy pick and mix merchandiser system;

FIG. 1b depicts the schematic view of the details of a front or rear loading stackable funnel and rake bin;

FIG. 2 depicts the engineering drawing of the front and side views of the candy pick and mix merchandiser system; and

FIG. 3 depicts the schematic view of the front and side views of the candy pick and mix merchandiser system with a different candy delivery bin configuration and theft deterrent enclosure; and

FIG. 4 depicts the schematic view of the front and side views of the candy pick and mix merchandiser system with shelves, which may be inclined at different angles with respect to the horizontal plane.

### DETAILED DESCRIPTION OF THE INVENTION

The present invention provides a candy pick and mix merchandiser system having modular components of varying and adjustable dimensions, and compact functions, that provide an exceedingly high and efficient storage and display capacity, as well as self-service dispense capability, on the smallest square feet footprint, as compared to existing bulk merchandiser systems.

Typically, conventional bulk merchandiser systems contain approximately 20 stock keeping units [SKUs], i.e. different product items, on a standard 48″ wide footprint. The pick and mix merchandiser system of my invention advantageously provides for the storage, display and self-service dispensing of 32 to 80 bulk stock keeping units (SKUs] or optionally approximately 240 packaged [SKUs] on the same 4 feet wide space. This space efficiency and SKU capacity ranges between 1.6 times and more than 5 times greater than other commercially available systems. Dependent on the combination of, and display ration between, bulk and packaged products, this SKU capacity is from 1.6 times up to approximately 12 times greater in storage, display and self-service capability than any other known and commercially available systems.

The components of the pick and mix system are arranged and contained on and in a supporting main frame. Optionally finished left and right sides, a back side, and base and top platforms create the mainframe module, which contains a variety of smaller stacked and otherwise arranged and installed components.

The general mainframe and specific pick and mix merchandiser system may be equipped optionally with a plurality of 4×1,200 lbs. capacity casters to provide easy and safe mobility. A rolling and weighted tambour door provides the mainframe with lock-down security during non-operating hours. Also provided by and forming a part of the pick and merchandiser system are a low voltage lighting system; a canopy; generic and proprietary graphics and signage; a satellite or integrated POS system; a cash register; an electronic scale and supplies; and an integrated bag holder.

One set of components comprises the proprietary acrylic or injection-molded funnel-and-rake-bins, scoop-bins, tongue- and open-bins for the storage, display, and self-service dispensing of unwrapped and wrapped bulk candies, bulk health foods and other bulk food products. The bin arrangements are typically stacked one bin on top of the other and secured and fastened vertically by means of four approximately ¼″ (0.220) high “tongues” on top of the bins and four approximately ¼″ (0.220) deep “grooves” that interlock to settle the bins in their space and to prevent the bins from moving forward, backward or sideways.

An additional set of components for the pick and mix merchandiser system comprises the optional arrangement of one to twelve matching shelves that can be positioned at varying degrees from 0 degree, i.e. a level position, to 45 degrees, i.e. the steepest incline. The varying degrees and inclines are used for the optional positioning of packaged product for storage, display and self-service dispensing. The shelves have a 2″ high lip in front and on both sides, but not in the back. This lip retains the packaged products in a well-organized and appealing position for viewing and self-service by customers. The optional inclines of the shelves are determined by the height at which they are installed. The higher the position of the shelves within the main frame, the more they will be inclined in the back by adjustable support pins that are fastened in pin-holes. The lower the position of the shelves within the main frame, the more they will be installed level to achieve best visibility and self-service access to the product by consumers.

An additional component is a three-step riser with adjustable and forward inclined acrylic boxes for the storage, display and self-service dispensing of wrapped and otherwise packaged candy, health food and other food products. This melamine and millwork riser is typically installed and positioned on the base platform inside the main frame, Above the riser are installed either the stackable and interlocking assorted bins or the adjustable shelves or any combination or configuration thereof.

The variable combinations of assorted acrylic or injection- molded self-service bin dispensers with the adjustable shelves and with the three-step riser allow for the storage, display and self-service dispensing of a hitherto unknown variety of self service bulk, wrapped, bagged or otherwise packaged candies, health foods and other foods that is not available with other self-service merchandising systems.

In addition, the pick and mix merchandiser system can be arranged in an aggregate and daisy-strung unlimited number of system units and bulk and count configurations, i.e. a string of ten systems dependent on the combination of, and display ratio between, bulk and packaged products, will provide for the storage, display and self-service dispensing of up to more than 2,400 SKUs on a foot print of no more than 100 square feet.

Optionally, the main frame can be fabricated in a width of less than four feet for the storage, display and self-service dispensing of bulk and packaged food products in the smallest floor or cash desk spaces.

The funnel and rake acrylic or injection-molded bins provide for the safe and hygienic storage, display and self-service of bulk and packaged food products. The enclosed design of the self-service funnel and rake bulk dispensers prevents the return of portioned and potentially polluted products into the dispensers. It prevents vandalism and abuse, and it minimizes airflow into and throughout the bin. Freshness, taste and flavor of the contained products are protected. Customers are able to self-service portion and self-service dispense only the desired smaller or larger amounts of hundreds of different candies, without being forced to purchase preexisting candy bags containing larger quantities a specific candy type.

The present invention provides a candy pick and mix merchandiser system that delivers an assortment of candy including wrapped hard candy, unwrapped candy, and the like, to a customer in a hygienic manner that minimizes contamination of unwrapped candy. The merchant benefits by enabling the customer to access a variety of candy. Customers choose exactly which type of candy they need and how much of it they would like to buy.

Generally stated, the candy pick and mix merchandiser system involves a candy merchandiser system for marketing a wide variety of candy in a space efficient manner. In one aspect of the invention, the candy pick and mix merchandiser system broadly comprises: (i) an adjustable merchandising vessel having exterior side walls, an exterior rear wall, an exterior top portion, and an exterior bottom portion that forms an interior compartment having an open aperture for receiving and housing candy dispensing bins or the like; (ii) the merchandising vessel's exterior side walls having at least one linking means adapted to connect with at least one other merchandising vessel to form a plurality of merchandising vessels linked together in a variety of configurations; (iii) the interior compartment of the merchandising vessel including at least one shelf having a slanted configuration angled in varying and adjustable degrees ranging from 0 to approximately 45 degrees from the horizontal plane; and (iv) the merchandising vessel being provided with a door adapted to prevent access to said interior compartment during non-operating hours; (v) a plurality of stackable candy delivery bins types including a) Front-Loading and Stacking Funnel & Rake Bins, b) Rear-Loading and Stacking Funnel & Rake Bin, c) Stackable Scoop Bin, d) Stackable Tongue Bin, and e) Stackable Open Bin; (vi) each of said stackable candy delivery bins further comprising two side surfaces, a top surface having a first stacking track, a bottom surface having a second stacking track, a candy delivery front portion, a vertical backside surface, and an angled backside surface; (vii) the candy delivery front portion in a front loading or a rear loading funnel and rake bin comprising an air minimizing entry member adapted to accommodate a candy rake handle, a candy aperture, and a candy port; and (viii) the candy port comprising a candy housing exit area and a candy exit hatch for dispensing candy from said delivery bin.

The merchandising vessel is constructed with a frame having a fixed width and a fixed height, but the depth of the vessel may be adjusted according to the preference of the merchandiser. A number of hardware provisions are provided to insert as much as 12 shelves. The angle of these shelves may be adjusted by setting risers located on the rear portion of the shelf support so that the shelves can be inclined at an angle ranging from 0 to approximately 45 degrees to a horizontal plane. A plurality of stackable candy bins are arranged, one above the other, to provide for display and delivery of candy therefrom. In an alternative embodiment, a stackable candy bin may be placed on any of these shelves and is therefore positioned at an angle suitable for free flow and delivery of the candy from the candy bin. The setting of this angle is important in the funnel and rake and tongue configurations of the stackable candy bin, especially when gummy candies are placed in the bin. In one embodiment, the stacked bins are provided with vertical stability strengthener means comprising plastic, acrylic or metal male and female plugs, which are inserted in vertically and horizontally parallel and side-by-side flush perforations in the frontal lower corners of the vertical left and right acrylic panels of the bins. In another embodiment, such vertical stability is strengthened by inserting two acrylic or metallic rods through holes provided in the left and right finished sides of the main frame and matching perforations in the frontal lower corners of the vertical left and right side panels of the acrylic or injection molded bin vessels.

The shelves may be used for displaying several candy items of irregular shapes, not suited for filling in stackable candy bins. Thus, the candy pick and mix merchandiser system can accommodate display of several candy delivery bins of assorted sizes as well as display of packaged candy. A front door, which is slidable prevents access to candy when the door is closed and locked.

Front or rear-loading and stackable candy pick and mix funnel and rake bins are used for unwrapped candy, confectionery and health food products. These bins comprise enclosed, stackable, tongue and groove storage, display and self-service acrylic bin apparatus having variable dimensions. The design of the bin apparatus enables the bins to achieve substantially increased efficiency, and to store, display and dispense via self-service a widely varying mix of bulk, novelty, count, proprietary and seasonal candy, health food and other products in virtually any environment and location that offers air conditioning, people traffic, people working, people waiting with time to spend, people entertaining themselves, and the like. Due to its unparalleled space efficiency and virtually infinite options of adjustable arrangements and configurations of modular components, the candy pick and mix merchandiser system is used for storage, display and self-service dispensing of a variety of bulk candy and health food products in places where they could not be offered for sale to date, such as convenience stores, card & gift stores, party supply stores, news kiosks, specialty stores, gourmet food stores, health food stores, ice cream and yogurt parlors, flower and general gift stores, bagel stores, bakeries, supermarkets, video rental stores, movie theatres, hotel gift shops, hospital gift shops, casino gift shops, cruise ship gift shops, gyms, turnpike/highway rest stops, college/university dining halls, airports, train stations, gas stations, theme parks, sports arenas, museums, zoos, car washes, office lobbies, private office cafeterias, party equipment rental firms, private home theatres, party and play rooms, military bases, candy importers and distributors, book stores, libraries, drug stores, game arcades, shop-in-shop boutiques, in-aisle kiosks, infinite wall placements, in-line stores, retail merchandizing units, and the like

The candy pick and mix merchandiser system enables an owner/operator to target markets otherwise unavailable. It provides an efficient space saving system adapted to accommodate continuous retail transactions in small retail space areas, small or high traffic areas. For example, the candy pick and mix merchandiser system has particular application in malls, train stations, schools, and other high traffic areas which are virtually inaccessible to candy merchants due to space constraints or rental rates associated with leasing store front space. The candy pick and mix merchandiser system allows a merchant to arrange a plurality of merchandising vessels in a variety of configurations, depending on designated space or design wishes. The candy delivery bins of the candy pick and mix merchandiser system are stackable upon one another and come in a vast array of sizes so that a merchant can effectively choose the size and presentment of the candy bins to accommodate a wide variety of bulk and packaged candy, confectionery and health foods, increased in-system inventory storage and improved display and self-service accessibility to the merchandise by the customer. Each of the candy delivery bins is provided with an angled backside surface, which represents an improvement over current bins by allowing rake accessibility to candies located in the back of the bin. Moreover, the candy delivery bins of the candy pick and mix merchandiser system are equipped with an air minimizing entry member that mitigates air born contaminants and prevents other undesirable substances from entering the candy bin. Advantageously, the candy pick and mix merchandiser system provides merchandisers with the ability to target markets that would otherwise be inaccessible or cost prohibitive. It provides a compact, efficient system capable of offering a vast array of candies for sale. These attributes enhance cost effectiveness of the merchandising system, enabling the merchant to maximize profits by minimizing cost of operations and rent in general, and labor cost in particular, due to the self-service functions of these systems, which require less attending staff.

Advantageously, the supporting main frame of the candy pick and mix merchandiser system accommodates an adjustable stackable and novel SKU variety ranging up to more than 12 times the capacity of conventional systems, i.e. up to more than 240 SKUs, dependent on the ratio between bulk and packaged products. That is to say, the system accommodates from a minimal number of SKUs, for example as few as 10 SKUs, to more than 12 times the capacity of conventional systems (i.e. more than 240 SKUs) on a compact footprint starting at 96 square inches and incrementally increasing to a standard width of 48 inches, a standard height of 82 inches and alternative depths of 18″, 24″ and 30″, respectively. This space efficiency allows for the storage, display and self-service dispensing of more than 6 packaged SKUs per fully stacked linear foot of shelf space.

The stacking concept is achieved by the application of 4 integrated tongues on top of each bin and 4 matching grooves on the bottom of each bin. The stability of up to 72″ high stacked towers and structure required to prevent the towers from tipping forward and collapsing due to “rake pull” is secured by the combination of the weight of the bins themselves, the weight of the candy and matching frontal perforations in the sides of the bins that tie them together via the insertion of a pair of male and female plugs. Advantageously, the structure provides for product-friendly and safe front loading without damage to sugar-coated hard shell candies, such as M&Ms, Jordan Almonds, and the like, without potential danger of injury to staff members, as is oftentimes experienced with top loading systems that feed via vertical chutes from heights of more than 8 feet. Typically, the acrylic apparatus of the candy pick and mix merchandiser system is adapted to store display and dispense using a width ranging from approximately 4″ to 10″, a depth ranging from approximately 12″ to 20″ and a height ranging from approximately 8″ to 12″.

The bin apparatus of the candy pick and mix merchandiser system is typically fabricated of 0.220″ thick acrylic sheet material or injection molded material. Such thickness is generally about ¼″ or 6 mm. This thickness provides for greater durability and improved function of the apparatus in high traffic environments. Optionally, a thickness of 0.155″ (i.e. 3/16″ or 4.5 mm) can be used, for the sake of economy.

Hygiene, sanitation and protection from pollutants is advantageously increased by minimizing human and environmental interference with product freshness and appearance. Air flow and exposure to the environment are minimized, thereby increasing product shelf life, and protecting nutritional values and ingredients to a greater extent than conventional scoop and tongue bins. Vandalism is deterred and protection is afforded against return of product into the apparatus after it has been dispensed and exposed to potentially unsanitary conditions.

A 3-dimensional shape in degrees of angles of the bin body and the funnel facilitates the consumers' desired control of self-service portioning and allows for the pick & mix of single pieces of candy per variety. If the declining angle of the base plate of the funnel were to be increased, i.e. if the base plate were to be lowered, the consumer might accidentally portion too much product and be unsatisfied and request the return of the product at the cash register. Advantageously, there is provided degrees of angels of the funnel that, despite the portion control desired, affords the unrestricted flow of all types of candies, whether dry and hard or moist and soft. If the declining angle of the base plate of the funnel were decreased, or if the base plate were lifted, moist candies, such as gummies, would not flow unrestricted from the bin through the funnel into the self-service bag underneath the opened funnel gate.

The candy pick and mix merchandiser system provides a loadable bin apparatus body volume for product storage, display and dispensing of at least 400 cubic inches, which allows for the complete loading and emptying of typical manufacturers' master cartons of 10 lbs. Or 2 typical master bags of 5 lbs. This convenience allows for complete storage of master cartons and bags in the bin apparatus without having to retain small remaining quantities in back storage. The body panels are disposed at angles that allow on the one hand for the easy raking and portioning of candy product into the funnel and, on the other hand, for sanitary surfaces and easy maintenance to prevent infestation and other pollution. In addition to these advantageous features, the rake and funnel action is designed to imitate the excitement of casino slot machines, and to increase the volume of candy purchased; and the value of dollars spent.

A. The Rear-Loading and Stacking Funnel & Rake Bin

The front is fully enclosed except for the rake and funnel openings. The rear-loading system involves a hinged cover on the rear third of the top of the bin apparatus. It provides for automatic product rotation, since the product is loaded in the rear third of the bin apparatus and automatically moved forward by the consumers' raking and portioning actions. A vertical retainer plate mounted immediately in front of the load opening retains all products at a horizontal level that will not allow the product to overflow into the funnel compartment without it actually being raked into it.

B. The Rake

The length of the rake is determined by the inside body depth of the given bin apparatus plus 2 inches. In an inactive position, the rake touches the inside rear panel of an empty bin apparatus. The guaranteed minimum protrusion outside the funnel face of the bin apparatus guarantees the customer convenient access to the rake and with that to the product. The rake is composed of cast acrylic, versus extruded acrylic, for greater durability, flexibility and resistance to crazing, a condition in which the acrylic material breaks down superficially and obtains an unattractive appearance. The tooth plate of the rake has sharpened tooth points for the user to transport soft and moist candies, such as gummies. The tooth points are close enough so that the rake also works with hard and dry candies, such as jelly beans, to portion and transport product into the funnel compartment.

C. The Stackable Scoop Bin

This economic, stackable and front loading alternative to the “funnel & Rake Bin” provides an economical alternative to the budget minded operator that does not want to invest in the more sanitary design and function and greater hygiene of the “Funnel & Rake Bin”. Instead of the removable funnel and rake face and portioning compartment and rake of the “Funnel & Rake Bin”, the “Scoop Bin” features a hinged lid that opens upward, next to which an acrylic pocket, which is permanently fixed inside the right side of the “Scoop Bin”, holds a plastic scoop on a tether. The pocket has an opening on the right side for the convenient cleaning and removal of sediment and pollutants from the scoop pocket.

D. The Stackable Tongue Bin

This bin is used for unwrapped candies, such as marshmallow twists and jelly rings that will be damaged or squashed with a rake or scoop.

E. The Stackable Open Bin

This bin is used for unwrapped, bagged and otherwise packaged confectionery items, only.

F. Fully Integrated Pick & Mix Main Frame Fixture

The fully integrated candy pick and Mix main frame fixture accommodates any combination of stacked bins and stores, displays and dispenses an unmatched variety of bulk, bagged and otherwise packaged candy, confectionery and health food products. It is optionally variable in height, width and depth to accommodate one to eight vertically stacked and cross-connected acrylic bulk bin towers from a minimum footprint of 1.5 sq. ft. to 10 sq. ft. The candy pick & mix main frame fixtures may be daisy-strung to operate in any size space and in any desirable configuration to store, display and dispense a wide variety of combinations of unwrapped “funnel & rake” bulk, unwrapped “scoop” bulk, unwrapped “tongue” bulk, wrapped bulk, bagged, boxed and otherwise packaged count, novelty gift, proprietary and seasonal candy, confectionery, health food and other food products. The candy pick and mix main frame can be constructed from a wide variety of optional materials, colors, finishes and hardware, such as natural woods, standard and custom melamine, plastic and metal finishes, standard and custom powder coatings, and the like.

G. Integrated and Adjustable Shelves

The candy pick and mix merchandiser system can accommodate up to 12 adjustable shelves in any combination, with stacked bins. These shelves can be adjusted from a level position of 90 degrees horizontal to inclines of varying angles to accommodate count, novelty, gift, proprietary, seasonal, bagged and otherwise packaged candy, confectionery and health food products of any width, height and depth that fits within the space of the main frame. The shelves are variable in width and depth with a 2″ high lip in front on either side to support and retain packaged product, especially when the shelf is in the higher and angled position. The angled position provides for an improved visibility of the displayed products and for a greater impulse purchase by the viewer.

H. Integrated and Adjustable Risers

The candy pick and mix merchandiser system can accommodate one-step, two-step or three-step risers for the storage, display and self-service dispensing of packaged candy and health food products. Above the riser, which is installed on the base of the main frame fixtures, any combination of “funnel & rake” bins, “scoop” bins, “tongue” bins and/or adjustable shelves can be arranged for the storage, display and self-service dispensing of candy and health food products. The risers can have varied heights, depths and widths.

I. Integrated Slat-Wall

The candy pick and mix merchandiser system can, optionally, be equipped with a full-size slat-wall against the inside full height and full width of the rear panel of the main frame. This option facilitates the storage, display and dispensing of bagged and otherwise packaged products; it adds to the virtually infinite assortment and variety of product combinations in multiple units. A fully integrated Point-Of-Sale station can be used for the operation of specified scales and cash registers, which are secured during off hours by the security and lock-down system. The integrated POS station applies if more than one pick and mix system is being operated, since it would take away too much storage and display space from product in a single operating unit.

J. Security and Lock Down

The mainframe fixture may be optionally secured with a spring-loaded and lockable tambour door, so that the entire system can be locked down and secured at night if it is located in a space that is accessible to the public. For budgeting purposes and savings, this security system is not required in locations that lock their own doors at night and do not allow access to outsiders. The security system is optionally available in heavy- and light duty finishes to be determined by given budget and security considerations.

K. Mobility

The candy pick and mix merchandiser system is mounted on non-lockable swivel casters with a weight capacity of 1,200 lbs, each. The fully loaded weight of the system may approach 1,000 lbs, so that a security factor of 1:4.8 is built into the system for durability and operating safety.

L. Lighting

The candy pick and mix merchandiser system is optionally provided with 2-way lighting comprising 8 MR 11 spot bulbs that flood the entire product display area to render the product more visible and appealing and to trigger a decision to purchase by the viewer.

M. Fire-Ratings

All materials used for fabrication of the candy pick and mix merchandiser system, including all optional components thereof, are available with fire ratings as may be required by municipal, state or federal zoning regulations and building departments. The candy pick and mix merchandisers are optionally provided with adjustable slat-wall components, adjustable pegboard components, integrated or free-standing bag/cup dispensers, integrated or free-standing Point-Of-Sale [POS] systems including cash registers, electronic scales and supplies, spillage troths and other optional components.

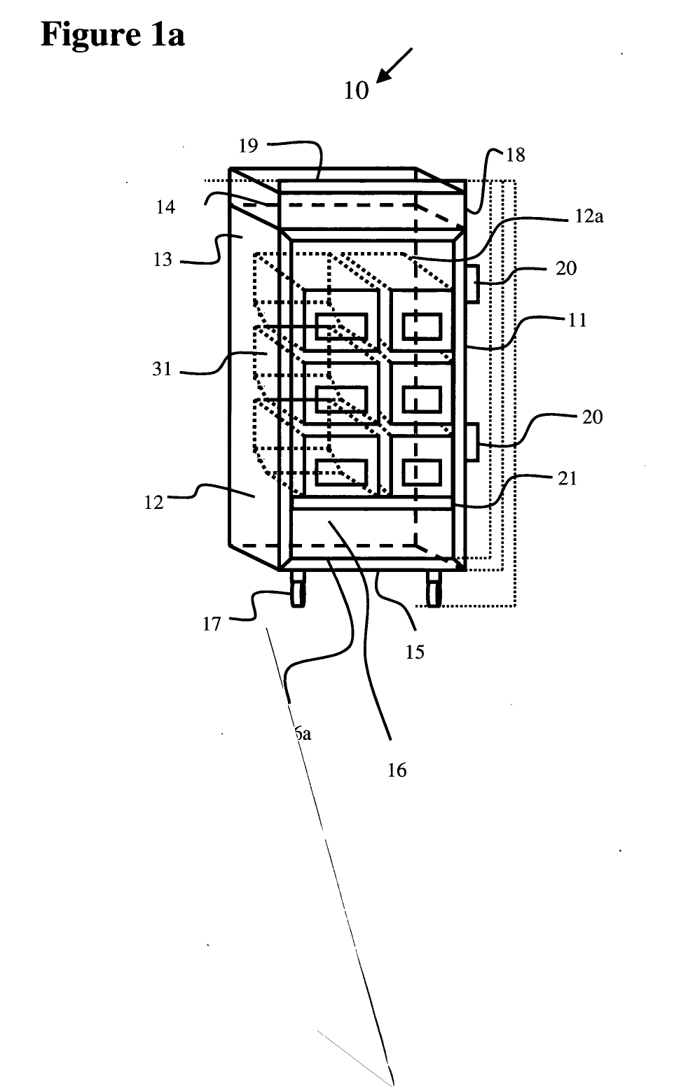

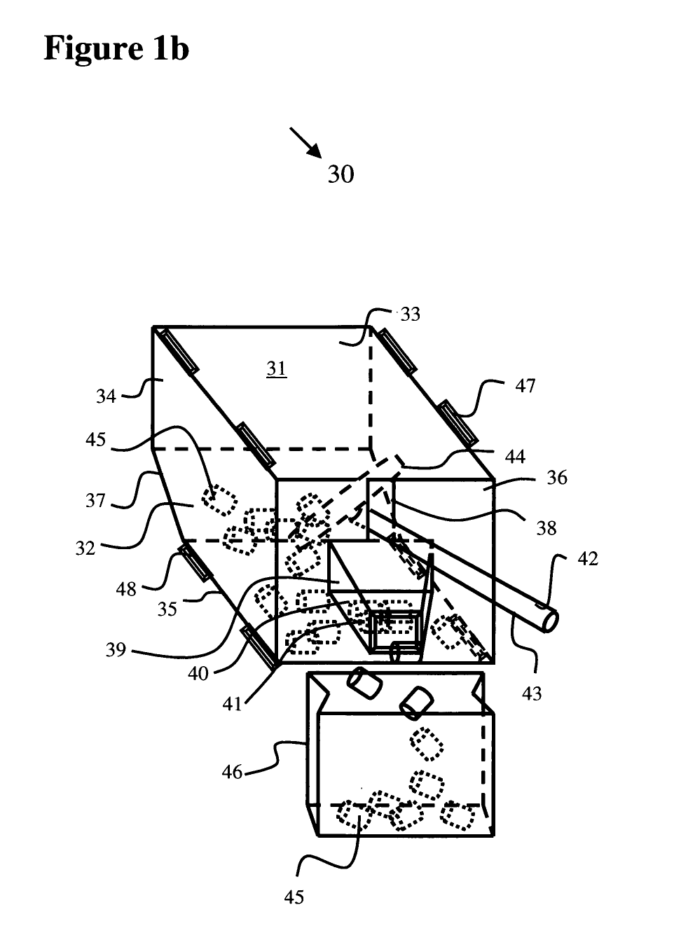

FIG. 1a illustrates a schematic view of the candy pick and mix merchandiser system, shown generally at 10. The candy pick and mix merchandiser system comprises an adjustable merchandising vessel 11. Merchandising vessel 11 further comprises exterior side walls 12, an exterior rear wall 13, an exterior top portion 14, and an exterior bottom portion 15 that collectively form an interior compartment 16. Interior compartment 16 is accessible through front aperture 16a. Interior compartment 16 and front aperture 16a are adapted for accessing, receiving and housing a plurality of stackable candy delivery bins 31 of merchandising vessel 11. The merchandising vessel 11 is shown herein as having an advertising portion 18 located above exterior top portion 14. Advertising portion 18 provides an area for advertising indicia or the like. An awning or canopy top 19 is provided on the exterior top portion 14 of merchandising vessel 11. Wheels 17 are also provided to allow mobility of the merchandising vessel 11. The merchandising vessel 11 can have multiple configurations and multiple sizes as indicated by phantom lines 12a. As shown herein, merchandising vessel 11 has a rectangular shape. The exterior side walls 12 of merchandising vessel 11 have at least one linking means 20 adapted to connect at least one other merchandising vessel 11 to form a plurality of merchandising vessels 11 linked together in a variety of configurations. This linking capability has particular application in the formation and configuration of kiosks. The interior compartment 16 of merchandising vessel 11 has at least one shelf area 21 adapted to house wrapped candies, bags, or other goods.

FIG. 1b illustrates at 30 a schematic view of the details of a front or rear loading stackable funnel and rake candy delivery bin 31 of the candy pick and mix merchandiser system. Each candy delivery bin 31 further comprises two side surfaces 32, a top surface 33, a bottom surface 35, a candy delivery front portion 36, a vertical backside surface 34, and an angled backside surface 37. Top surface 33 has a first stacking track 47; bottom surface 35 has a second stacking track 48. The first stacking track 47 of first delivery bin 31 is adapted to receive a second stacking track 48 found on bottom surface 35 of second delivery bin 31 placed on top thereof. In a preferred embodiment of the invention, these delivery bin stacks are held in place and prevented from tipping by the insertion of metallic or acrylic rods through holes in the vessel 11, passing through holes in the stacked bins. Delivery front portion 36 further comprises an air minimizing entry member 38 adapted to accommodate a candy rake handle 43 of candy rake 42. Candy rake 42 comprises a rake portion 44 housed within candy delivery bin 31, and candy rake handle 43. Delivery front portion 36 further comprises a candy aperture 39, and a candy port 40. Candy port 40 comprises a candy housing exit area 41 and a candy exit hatch (not shown in FIG. 1b) for dispensing candy 45 from delivery bin 31 into bag 46.

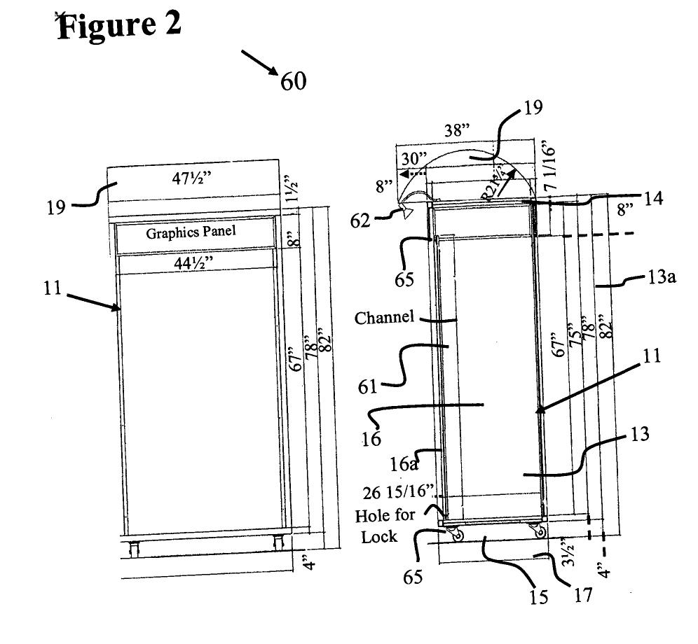

FIG. 2 illustrates the engineering drawings of the front and side views of the candy pick and mix merchandiser system, shown generally at 60. The candy pick and mix merchandiser system comprises a merchandising vessel 11 having various dimensions, shown as 13a indicating various dimensions for exterior top portion 14 and exterior bottom portion 15; thereby extending the distance of exterior rear wall 13 from front aperture 16a and increasing the capacity of interior compartment 16. A plurality of holes 65 are provided for insertion of metallic rods to retain stacks of delivery bins. A side view of awning 19 is shown. The merchandising vessel 11 is provided with a display light 62. Alternatively, merchandising vessel 11 is provided with a door 61 adapted to close over front aperture 16a, thereby preventing access to interior compartment 16 during non-operating hours.

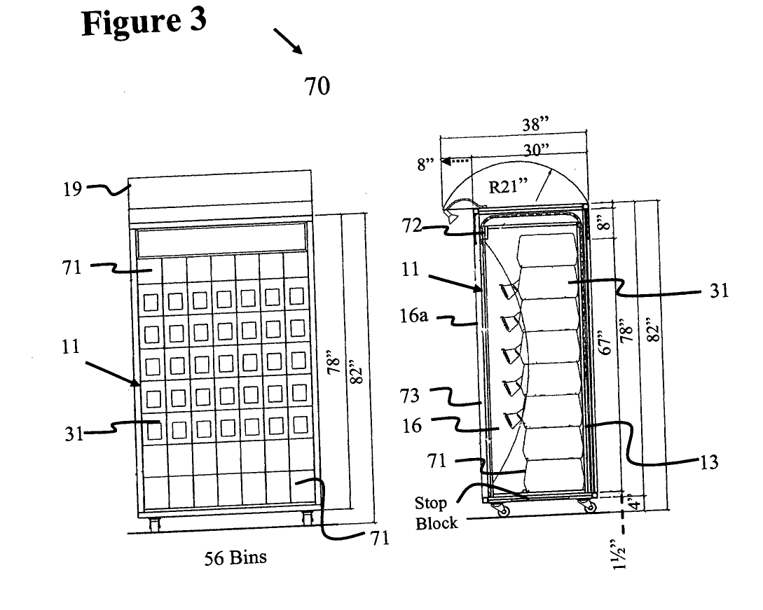

FIG. 3 illustrates front and side views of the candy pick and mix merchandiser system with a different candy delivery bin configuration and theft deterrent enclosure, shown generally at 70. The front view of the candy pick and mix merchandiser system is shown, illustrating the merchandising vessel 11 provided with candy delivery bins 31 and other bins or containment devices 71. The side view of the candy pick and mix merchandiser system shows candy delivery bins 31 stacked one above the other within the merchandising vessel 11. A rolling door track 72 with rolling door 73 is provided. The rolling door track 72 extends from behind delivery bins 31 and parallel to exterior rear wall 13. Rolling door track 72 delivers rolling door 73 over front aperture 16a and prevents access to interior compartment 16.

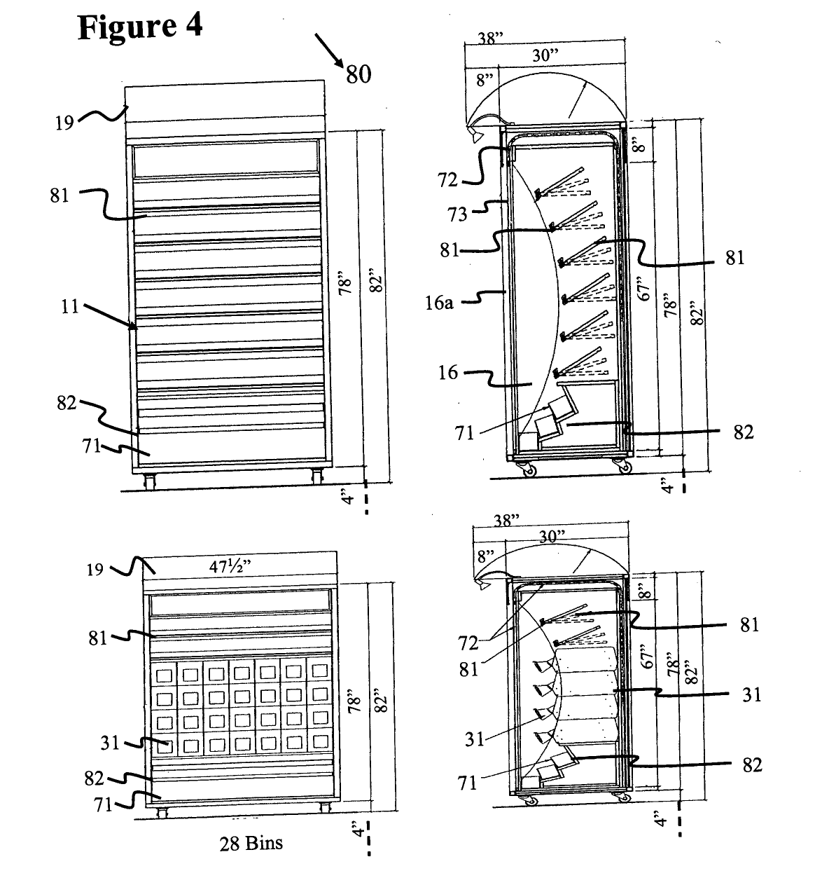

FIG. 4 illustrates front and side views of the candy pick and mix merchandiser system with shelves, which may be inclined at different angles with respect to the horizontal plane, shown generally at 80. The front view of the candy pick and mix merchandiser system illustrates the merchandising vessel 11 provided with storage area 82. The storage area 82 is adapted to house a plurality of bins, which can comprise either the candy delivery bins 31 of the candy pick and mix merchandiser system or bins from another source. The merchandising vessel 11 is provided with at least one shelf 81, shown herein as a plurality of shelves 81. Preferably, shelves 81 have a slanted configuration to provide optimal access to the goods located on each of the shelves 81. The side view of the candy pick and mix merchandiser system shows storage area 82, either for the candy delivery bins 31 of the candy pick and mix merchandiser system or bins from another source. Shelves 81 are shown at a slant, and are appointed for housing bins, boxes, or wrapped goods. Interior compartment 16 and front aperture 16a are adapted for accessing the merchandising vessel 11 and visa vie the shelves 81 and storage area 82. A rolling door 73 on rolling door track 72 is provided to close access to interior compartment 16. The bottom side view, shown generally at 90, illustrates the candy pick and mix merchandiser system having a plurality of angle adjustable shelves 81, a plurality of candy delivery bins 31, and storage area 82.

Having thus described the invention in rather full detail, it will be understood that such detail need not be strictly adhered to, but that additional changes and modifications may suggest themselves to one skilled in the art, all falling within the scope of the invention as defined by the subjoined claims.

What is claimed is:

1. A candy pick and mix merchandiser system, comprising:
a. a depth adjustable merchandiser vessel for receiving plurality of shelves and a plurality of vertically stackable candy delivery bins of different sizes and configurations;
b. connecting means for attaching merchandiser vessels to one another to create an array of merchandiser vessels delivering a large variety of candies;
c. tongue and groove attachment means for attaching and interlocking said vertically stackable candy delivery bins to form a stacked configuration wherein the bins are stacked one over another in an interlocked array;
d. vertical stability strengthener means for strengthening said interlocked array of vertically stacked candy bins;
e. shelf supporting and angle inclination means for adjusting the angle of said shelves;
f. said candy delivery bin configuration being selected from Front-Loading and Stacking Funnel and Rake Bins, Rear-Loading and Stacking Funnel and Rake Bins, Stackable Scoop Bins, Stackable Tongue Bins, and Stackable Open Bins;
whereby said candy pick and mix merchandiser system delivers a variety of candies in an efficient, hygienic manner.

2. A candy pick and mix merchandiser system as recited by claim 1, wherein said vertically stackable candy delivery bins are composed of acrylic polymer.

3. A candy pick and mix merchandiser system as recited by claim 1, wherein said vertically stackable candy delivery bins have a width ranging from approximately 4″ to 10″, a depth ranging from approximately 12″ to 20″ and a height ranging from approximately 8″ to 12″.

4. A candy pick and mix merchandiser system as recited by claim 1, wherein said shelf supporting and angle inclination mean includes support brackets and height adjustable risers.

5. A candy pick and mix merchandiser system as recited by claim 4, wherein said shelf angle inclination is adapted to be adjusted within a range of about 0 to 45 degrees, the angle being measured with respect to a horizontal plane.

6. A candy pick and mix merchandiser system as recited by claim 1, wherein said Front-Loading and Stacking Funnel and Rake Bins, and said Rear-Loading and Stacking Funnel and Rake Bins are provided with a funnel and a rake passing through a narrow aperture above said funnel, and candy is manually raked towards a delivery chute at the front of each of the bins.

7. A candy pick and mix merchandiser system as recited by claim 1, wherein said vertical stability strengthener means comprises a plurality of male and female plugs adapted for insertion into a plurality of vertically and horizontally parallel and side-by-side flush perforations in frontal lower corners of vertically disposed left and right acrylic panels of said bins.

8. A candy pick and mix merchandiser system as recited by claim 1, wherein said vertical stability strengthener means includes a plurality of metallic rods adapted to pass through apertures in each of said vertically stacked candy delivery bins, at least two of said rods passing through a pair of apertures, one of the two apertures being in the top and the other aperture being in the bottom of said merchandiser vessel.

9. A candy pick and mix merchandiser system as recited by claim 2, wherein said vertically stackable candy delivery bins are composed of acrylic sheet.

10. A candy pick and mix merchandiser system as recited by claim 1, wherein said vertically stackable candy delivery bins are composed of an injection molded acrylic material.

11. A candy pick and mix merchandiser system as recited by claim 1, wherein said vertical stability strengthener means includes a plurality of acrylic rods adapted to pass through apertures in each of said vertically stacked candy delivery bins, at least two of said rods passing through a pair of apertures, one of the two apertures being in the top and the other aperture being in the bottom of said merchandiser vessel.

12. A candy pick and mix merchandiser system, comprising:
a. a depth adjustable merchandiser vessel for receiving a plurality of shelves and a plurality of vertically stackable candy delivery bins of different sizes and configurations;
b. connecting means for attaching a plurality of merchandiser vessels to one another, thereby creating an array of merchandiser vessels adapted to deliver a large variety of candies;
c. tongue and groove attachment means for attaching and interlocking together said vertically stackable candy delivery bins, thereby creating a stacked configuration wherein said bins are stacked one over another in an interlocked array;
d. vertical stability strengthener means for strengthening said interlocked array of vertically stacked candy bins;
e. shelf supporting and angle inclination means for adjusting the angle of said shelves;
f. said candy delivery bin configuration being a member selected from the group consisting of Front-Loading and Stacking Funnel and Rake Bins, Rear-Loading and Stacking Funnel and Rake Bins, Stackable Scoop Bins, Stackable Tongue Bins, and Stackable Open Bins;
g. the merchandiser vessel being provided with a slidable rolling door sliding on a rolling door track to lock the candy pick and mix merchandiser system and thereby prevent vandalism;
whereby said candy pick and mix merchandiser system delivers a variety of candies in an efficient, hygienic, cost effective manner.
